(19) United States
(12) Patent Application Publication
(10) Pub. No.: US 2026/0185714 A1
(43) Pub. Date: Jul. 2, 2026

(54) METHOD FOR OPERATING GAS TURBINE

(71) Applicant: MITSUBISHI HEAVY INDUSTRIES LTD., Tokyo (JP)

(72) Inventors: Satoshi TANIMURA, Tokyo (JP); Sosuke NAKAMURA, Tokyo (JP); Tomo KAWAKAMI, Tokyo (JP); Teruhiro MATSUMOTO, Tokyo (JP); Mitsuhiro MORISHITA, Tokyo (JP); Shohei DOMEN, Tokyo (JP); Akinori ICHIKAWA, Tokyo (JP)

(21) Appl. No.: 19/130,313

(22) PCT Filed: Nov. 21, 2023
(86) PCT No.: PCT/JP2023/041780

§ 371 Date: May 15, 2025

(30) Foreign Application Priority Data
Dec. 1, 2022 (JP) 2022-192571

(51) Int. Cl. F23R 3/36; F02C 3/22; F02C 3/30

(52) U.S. Cl. CPC F23R 3/36; F02C 3/22; F02C 3/30

(57) ABSTRACT

A method for operating a gas turbine according to one embodiment is for operating a gas turbine including a combustor that can use hydrogen and a fuel other than hydrogen as fuel. This combustor includes a nozzle having at least one first injection hole and at least one second injection hole. When performing low hydrogen co-firing rate operation, a first fuel is injected from the at least one first injection hole, and when performing high hydrogen co-firing rate operation, in which the hydrogen co-firing rate is higher than in the low hydrogen co-firing rate operation, a second fuel having a higher hydrogen content than the first fuel is injected from the at least one first injection hole, and water is injected from the second injection hole.

### TECHNICAL FIELD

The present disclosure relates to an operation method for a gas turbine.

The present application claims priority based on Japanese Patent Application No. 2022-192571 filed in Japan on Dec. 1, 2022, the contents of which are incorporated herein by reference.

### BACKGROUND ART

For example, in a thermal power plant, as means for reducing a discharge amount of carbon dioxide (CO₂), which is a cause of global warming, it is being considered to improve power generation efficiency or actively use fuel such as hydrogen other than fossil fuel (for example, refer to PTL 1).

### CITATION LIST

### Patent Literature

[PTL 1] Japanese Unexamined Patent Application Publication No. 2021-046949

### SUMMARY OF INVENTION

### Technical Problem

In order to reduce the discharge amount of the carbon dioxide, it is desirable to increase a co-combustion rate of the hydrogen. However, when the co-combustion rate of the hydrogen is increased, a temperature of a flame tends to rise, and an amount of NOₓ generated tends to increase. In addition, there is a concern that a metal temperature of a combustor may rise due to the rise in the temperature of the flame, thereby causing damage.

In view of the above-described circumstances, an object of at least one embodiment of the present disclosure is to suppress a generation of NOₓ while increasing a co-combustion rate of hydrogen and to suppress a possibility of damage to a combustor when operating a gas turbine.

### Solution to Problem

(1) An operation method for a gas turbine according to at least one embodiment of the present disclosure is
an operation method for a gas turbine including a combustor capable of using hydrogen and fuel other than hydrogen as fuel, in which the combustor includes a nozzle having at least one first injection hole and at least one second injection hole, the method including:
injecting first fuel from the at least one first injection hole in a case of performing an operation at a low hydrogen co-combustion rate; and
injecting second fuel having a higher hydrogen content than the first fuel from the at least one first injection hole and injecting water from the second injection hole in a case of performing an operation at a high hydrogen co-combustion rate, in which a hydrogen co-combustion rate is higher than the operation at the low hydrogen co-combustion rate.

### Advantageous Effects of Invention

According to at least one embodiment of the present disclosure, it is possible to suppress a generation of NOₓ while increasing a co-combustion rate of hydrogen and to suppress a possibility of damage to a combustor when operating a gas turbine.

### BRIEF DESCRIPTION OF DRAWINGS

FIG. 1 is a schematic configuration view illustrating a gas turbine according to some embodiments.

FIG. 2 is a sectional view illustrating a combustor according to some embodiments.

FIG. 3 is a sectional view illustrating a main part of the combustor according to some embodiments.

FIG. 4 is a view schematically illustrating a disposition of each fuel nozzle when the combustor according to some embodiments is viewed from a downstream side to an upstream side along an axial direction of the combustor.

FIG. 5 is a view illustrating an outline of a structure in a vicinity of a tip of a pilot nozzle in the combustor according to some embodiments and an outline of a supply system.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

### About Gas Turbine 1

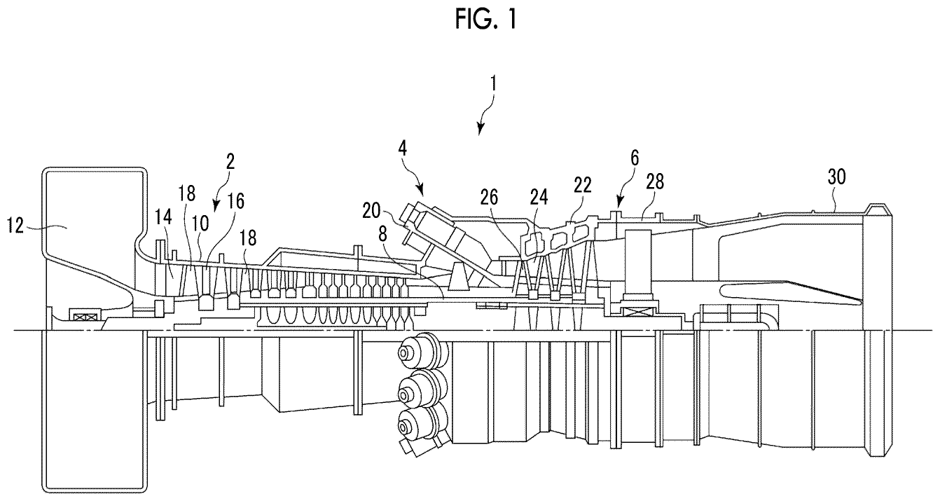

FIG. 1 is a schematic configuration view illustrating a gas turbine 1 according to some embodiments.

A gas turbine, which is an example of an application target of an operation method for a gas turbine according to some embodiments, will be described with reference to FIG. 1.

As illustrated in FIG. 1, the gas turbine 1 operated by the operation method for a gas turbine according to some embodiments includes a compressor 2 for generating compressed air as an oxidizer, a gas turbine combustor 4 for generating combustion gas by using the compressed air and fuel, and a turbine 6 configured to be rotationally driven by the combustion gas. In a case of the gas turbine 1 for power generation, a generator (not illustrated) is connected to the turbine 6, and power generation is performed by rotational energy of the turbine 6. In the following description, the gas turbine combustor 4 will also be simply referred to as a combustor 4.

Specific configuration examples of each part in the gas turbine 1 according to some embodiments will be described.

The compressor 2 according to some embodiments includes a compressor casing 10, an air intake port 12 provided on an inlet side of the compressor casing 10 to take in air, a rotor 8 provided to penetrate both the compressor casing 10 and a turbine casing 22 to be described later, and various blades disposed in the compressor casing 10. The various blades include an inlet guide blade 14 provided on a side of the air intake port 12, a plurality of stator vanes 16 fixed to a side of the compressor casing 10, and a plurality of rotor blades 18 embedded in the rotor 8 to be alternately arranged with respect to the stator vanes 16. The compressor 2 may include other components such as a bleed air chamber (not illustrated). In such a compressor 2, the air taken in from the air intake port 12 passes through the plurality of stator vanes 16 and the plurality of rotor blades 18 and is compressed to be high-temperature and high-pressure compressed air. The high-temperature and high-pressure compressed air is sent from the compressor 2 to the combustor 4 in a rear stage.

The combustor 4 according to some embodiments is disposed inside a casing 20. As illustrated in FIG. 1, a plurality of the combustors 4 may be disposed annularly around the rotor 8 in the casing 20. The combustor 4 is supplied with the fuel and the compressed air generated by the compressor 2, and combusts the fuel to generate combustion gas which is a working fluid of the turbine 6. The combustion gas is sent from the combustor 4 to the turbine 6 in the rear stage. A configuration example of the combustor 4 according to some embodiments will be described later.

The turbine 6 according to some embodiments includes the turbine casing 22 and various blades disposed within the turbine casing 22. The various blades include a plurality of stator vanes 24 fixed to a side of the turbine casing 22, and a plurality of rotor blades 26 embedded in the rotor 8 to be alternately arranged with respect to the stator vanes 24. The turbine 6 may include other components such as an outlet guide blade. In the turbine 6, the rotor 8 is rotationally driven by causing the combustion gas to pass through the plurality of stator vanes 24 and the plurality of rotor blades 26. In this way, the generator connected to the rotor 8 is driven.

An exhaust chamber 30 is connected to a downstream side of the turbine casing 22 through an exhaust casing 28. After the turbine 6 is driven, the combustion gas is discharged to an outside via the exhaust casing 28 and via the exhaust chamber 30.

### About Combustor 4

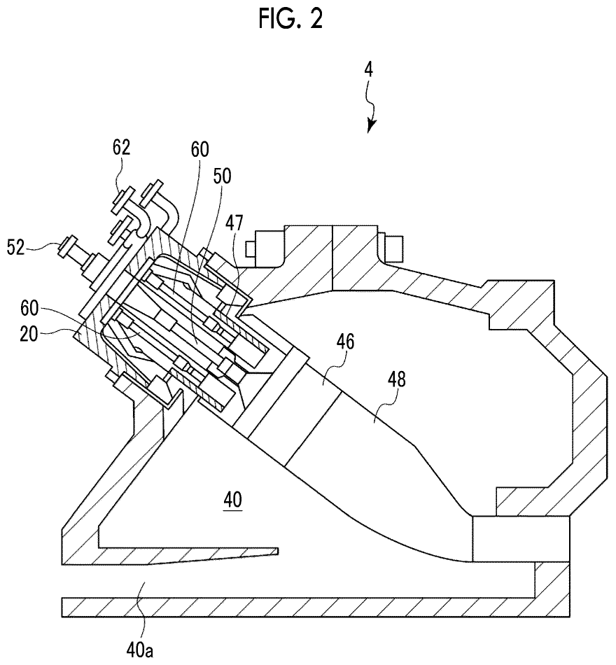

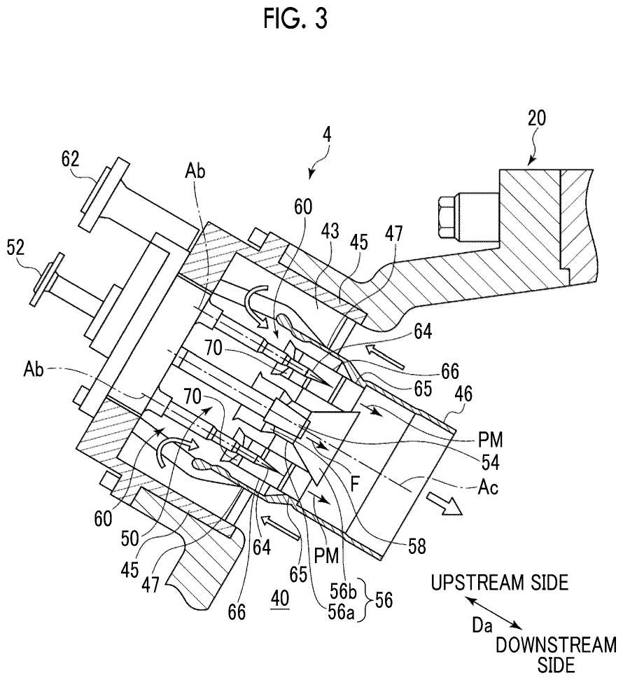

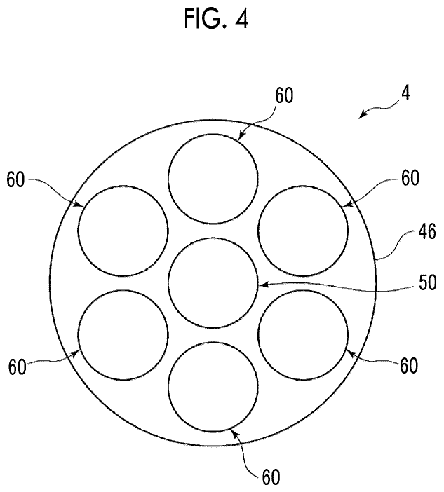

FIG. 2 is a sectional view illustrating the combustor 4 according to some embodiments. FIG. 3 is a sectional view illustrating a main part of the combustor 4 according to some embodiments. FIG. 4 is a view schematically illustrating a disposition of each fuel nozzle when the combustor 4 according to some embodiments is viewed from a downstream side to an upstream side along an axial direction of the combustor 4.

A configuration of the combustor 4 according to some embodiments will be described with reference to FIGS. 2, 3, and 4.

As illustrated in FIGS. 2 and 3, the plurality of the combustors 4 according to some embodiments are disposed annularly around the rotor 8 (refer to FIG. 1). Each of the combustors 4 includes a combustor liner 46 provided in a combustor casing 40 defined by the casing 20, and a main combustion burner 60 and a pilot combustion burner 50 which are fuel nozzles disposed in the combustor liner 46, respectively.

The combustor 4 further includes an outer cylinder 45 provided on an outer peripheral side of an inner cylinder 47 of the combustor liner 46 inside the casing 20. An air passage 43 through which the compressed air flows is formed on the outer peripheral side of the inner cylinder 47 and an inner peripheral side of the outer cylinder 45.

The combustor 4 may include other components such as a bypass pipe (not illustrated) for bypassing the combustion gas.

For example, the combustor liner 46 includes the inner cylinder 47 disposed around the pilot combustion burner 50 and a plurality of the main combustion burners 60, and a transition piece 48 connected to a tip portion of the inner cylinder 47. That is, the combustor liner 46 corresponds to a combustion portion in which fuel F injected from the main combustion burner 60 and from the pilot combustion burner 50 is combusted.

As illustrated in FIGS. 3 and 4, the pilot combustion burner 50 is disposed along a central axis of the combustor liner 46. The plurality of the main combustion burners 60 are disposed side by side to be spaced apart from each other in a circumferential direction to surround an outer peripheral side of the pilot combustion burner 50.

As illustrated in FIG. 3, the pilot combustion burner 50 includes a pilot nozzle 54 connected to a fuel port 52, a pilot burner cylinder 56 disposed to surround the pilot nozzle 54, and a plurality of swirlers (swirl plates) 58 provided on an outer periphery of the pilot nozzle 54.

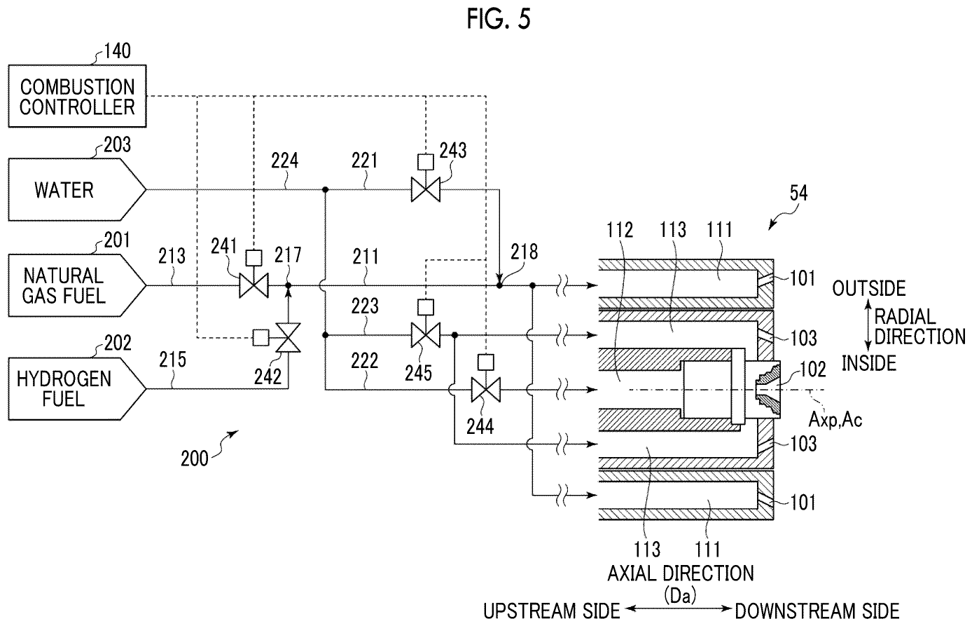

The pilot nozzle 54 extends in an axial direction Da about a combustor axis Ac. Here, an upstream side which is one side in the axial direction Da, which is an extending direction of the combustor axis Ac, and is along a flow of the combustion gas is an upstream side, and a downstream side which is the other side and is along the flow of the combustion gas is a downstream side. In addition, the combustor axis Ac (central axis Axp: refer to FIG. 5 described later) is also a burner axis of the pilot combustion burner 50.

An injection hole (not illustrated) for injecting the fuel F is formed in a downstream-side end portion of the pilot nozzle 54. The plurality of swirl plates 58 are provided on an upstream side of a position where the injection hole is formed in the pilot nozzle 54. Each of the swirl plates 58 is for swirling the compressed air about the combustor axis Ac. Each of the swirl plates 58 extends in a direction including a radial component from the outer periphery of the pilot nozzle 54 and is close to an inner peripheral surface of the pilot burner cylinder 56. The pilot burner cylinder 56 has a main body portion 56a located on the outer periphery of the pilot nozzle 54, and a cone portion 56b which is connected to a downstream side of the main body portion 56a and of which a diameter gradually increases toward the downstream side. The plurality of swirl plates 58 are close to an inner peripheral surface of the main body portion 56a in the pilot burner cylinder 56.

The main combustion burner 60 includes a main nozzle 64 connected to a fuel port 62, a main burner cylinder 66 disposed to surround the main nozzle 64, an extension pipe 65 that connects the main burner cylinder 66 and the combustor liner 46 (for example, inner cylinder 47), and a swirler (swirl plate) 70 provided on an outer periphery of the main nozzle 64.

The main nozzle 64 is a rod-shaped nozzle that extends in the axial direction Da about a burner axis Ab parallel to the combustor axis Ac. Since the burner axis Ab of the main combustion burner 60 is parallel to the combustor axis Ac, the axial direction Da with respect to the combustor axis Ac and the axial direction Da with respect to the burner axis Ab are the same direction. In addition, the upstream side in the axial direction Da with respect to the combustor axis Ac is an upstream side in the axial direction Da with respect to the burner axis Ab, and the downstream side in the axial direction Da with respect to the combustor axis Ac is a downstream side in the axial direction Da with respect to the burner axis Ab.

An injection hole for injecting the fuel F is formed in an intermediate portion of the main nozzle 64 in the axial direction Da. A plurality of the swirl plates 70 are provided in a vicinity of a position where the injection hole is formed in the main nozzle 64. Each of the swirl plates 70 is for swirling the compressed air about the burner axis Ab. Each of the swirl plates 70 extends in a direction including a radial component from the outer periphery of the main nozzle 64 and is close to an inner peripheral surface of the main burner cylinder 66. The main burner cylinder 66 is located on the outer periphery of the main nozzle 64.

In the combustor 4 having the above-described configuration, the compressed air generated by the compressor 2 is supplied from a casing inlet 40a into the combustor casing 40, and further flows from the combustor casing 40 into the pilot burner cylinder 56 and into a plurality of the main burner cylinders 66 via the air passage 43.

In the pilot combustion burner 50, the fuel F injected from the pilot nozzle 54 is jetted from a downstream end of the pilot burner cylinder 56 together with the compressed air. The fuel F is diffused and combusted or premixed and combusted in the combustor liner 46.

That is, the pilot combustion burner 50 illustrated in FIGS. 2, 3, and 4 is a diffusion combustion type or pre-mixed combustion type fuel nozzle.

In the main combustion burner 60, the compressed air and the fuel F injected from the main nozzle 64 are mixed in the main burner cylinder 66 to form premixed gas PM. In the main combustion burner 60, the premixed gas PM is jetted from a downstream end of the extension pipe 65. The fuel F in the premixed gas PM is premixed and combusted in the combustor liner 46.

That is, the main combustion burner 60 illustrated in FIGS. 2, 3, and 4 is a pre-mixed combustion type fuel nozzle.

An injection hole for injecting the fuel F may be formed in the swirl plate 70, and the fuel F may be injected into the main burner cylinder 66 through the injection hole. In this case, a portion corresponding to the rod-shaped main nozzle 64 described above forms a hub rod, and a main nozzle is formed with the hub rod and the plurality of the swirl plates 70. The fuel F from the outside is supplied into the hub rod, and the fuel F is supplied from the hub rod to the swirl plate 70.

### About Fuel F

The combustor 4 according to some embodiments is configured to, as the fuel F, use natural gas, for example, as in the case of a combustor in the related art, as well as hydrogen. In the following description, natural gas as the fuel F is referred to as natural gas fuel FN or simply as natural gas. Similarly, in the following description, hydrogen as the fuel F is referred to as hydrogen fuel FH or simply as hydrogen.

In addition, in the following description, when there is no need to particularly distinguish the natural gas fuel FN, the hydrogen fuel FH, and mixed fuel FM of the natural gas fuel FN and the hydrogen fuel FH, or when these types of fuel are collectively referred to, the types of fuel are referred to as fuel F.

### About Outline of Structure of Pilot Nozzle 54

FIG. 5 is a view illustrating an outline of a structure in a vicinity of a tip of the pilot nozzle 54 in the combustor 4 according to some embodiments and an outline of a supply system 200 for supplying the fuel F and water W to the pilot nozzle 54.

A sectional view of the pilot nozzle 54 illustrated in FIG. 5 illustrates a cross section taken along the central axis Axp (combustor axis Ac) of the pilot nozzle 54.

The pilot nozzle 54 according to some embodiments may include at least one first injection hole 101, at least one second injection hole 102, and at least one third injection hole 103. In the pilot nozzle 54 illustrated in FIG. 5, a plurality of the first injection holes 101 and the third injection holes 103 are provided at intervals in a circumferential direction about the central axis Axp of the pilot nozzle 54, and one second injection hole 102 is provided on the central axis Axp.

In the pilot nozzle 54 according to some embodiments, each of the first injection holes 101 is disposed outside the third injection hole 103 and the second injection hole 102 in a radial direction about the central axis Axp, and is configured to inject the fuel For a mixture FW of the fuel F and the water W injected from each of the first injection holes 101 diagonally outwards in the radial direction, as will be described later.

In the pilot nozzle 54 according to some embodiments, each of the second injection holes 102 is configured to inject the water W injected from the second injection hole 102 while spreading to the outside in the radial direction, as will be described later.

In the pilot nozzle 54 according to some embodiments, each of the third injection holes 103 is disposed inside the first injection hole 101 in the radial direction and outside the second injection hole 102 in the radial direction, and is configured to inject the water W injected from each of the third injection holes 103 diagonally inwards in the radial direction, as will be described later.

The pilot nozzle 54 according to some embodiments is provided with a first flow path 111 for supplying the fuel F or the mixture FW of the fuel F and the water W to each of the first injection holes 101. In the pilot nozzle 54 according to some embodiments, the first flow path 111 may be one annular flow path of which a cross section orthogonal to the central axis Axp is annular, or may be a plurality of flow paths extending in an extending direction (axial direction) of the central axis Axp and formed at intervals in the circumferential direction about the central axis Axp.

The pilot nozzle 54 according to some embodiments is provided with a second flow path 112 for supplying the water W to the second injection hole 102. In the pilot nozzle 54 according to some embodiments, the second flow path 112 is a flow path extending in the axial direction at a center position in the radial direction.

The pilot nozzle 54 according to some embodiments is provided with a third flow path 113 for supplying the water W to each of the third injection holes 103. In the pilot nozzle 54 according to some embodiments, the third flow path 113 may be one annular flow path of which a cross section orthogonal to the central axis Axp is annular, or may be a plurality of flow paths extending in the axial direction and formed at intervals in the circumferential direction about the central axis Axp.

### About Supply System 200

The gas turbine 1 according to some embodiments includes the supply system 200 illustrated in FIG. 5. The supply system 200 illustrated in FIG. 5 includes a fuel supply line 211 for supplying the fuel F to the first flow path 111 of the pilot nozzle 54, a first water supply line 221 for supplying the water W to the first flow path 111, a second water supply line 222 for supplying the water W to the second flow path 112 of the pilot nozzle 54, and a third water supply line 223 for supplying the water W to the third flow path 113 of the pilot nozzle 54.

In the supply system 200 illustrated in FIG. 5, a natural gas supply line 213 for supplying the natural gas fuel FN from the supply source 201 for the natural gas fuel FN to the fuel supply line 211 and a hydrogen supply line 215 for supplying the hydrogen fuel FH from the supply source 202 for the hydrogen fuel FH to the fuel supply line 211 are connected to the fuel supply line 211 at a merging portion 217.

The supply system 200 illustrated in FIG. 5 includes a natural gas regulation valve 241 provided in the natural gas supply line 213 to regulate a flow rate of the natural gas fuel FN supplied to the fuel supply line 211, and a hydrogen regulation valve 242 provided in the hydrogen supply line 215 to regulate a flow rate of the hydrogen fuel FH supplied to the fuel supply line 211.

The supply system 200 illustrated in FIG. 5 includes a water supply line 224 for supplying the water W from a supply source 203 for the water W to the first water supply line 221, to the second water supply line 222, and to the third water supply line 223.

The first water supply line 221 is provided with a first water regulation valve 243 for regulating a flow rate of the water W supplied to the first flow path 111 of the pilot nozzle 54. A downstream end of the first water supply line 221 is connected to the fuel supply line 211 at a merging portion 218 on a downstream side of the merging portion 217.

The second water supply line 222 is provided with a second water regulation valve 244 for regulating a flow rate of the water W supplied to the second flow path 112 of the pilot nozzle 54.

The third water supply line 223 is provided with a third water regulation valve 245 for regulating a flow rate of the water W supplied to the third flow path 113 of the pilot nozzle 54.

The natural gas regulation valve 241, the hydrogen regulation valve 242, the first water regulation valve 243, the second water regulation valve 244, and the third water regulation valve 245 are controlled by a controller configured to control each of the regulation valves. In some embodiments, the controller is realized by a combustion controller 140 of the gas turbine 1.

Each processing function of the combustion controller 140 is configured by software (computer program) and is executed by a computer, but is not limited thereto, and may be configured by hardware.

In the gas turbine 1 according to some embodiments, the fuel F supplied to the first flow path 111 of the pilot nozzle 54 is the natural gas fuel FN, the mixed fuel FM of the natural gas fuel FN and the hydrogen fuel FH, or the hydrogen fuel FH. That is, a hydrogen co-combustion rate in the pilot combustion burner 50 is 0% or more and 100% or less. The hydrogen co-combustion rate in the pilot combustion burner 50 is controlled by the combustion controller 140 regulating opening degrees of the natural gas regulation valve 241 and the hydrogen regulation valve 242.

Although detailed description is omitted, in the gas turbine 1 according to some embodiments, each of the main combustion burners 60 is also configured to combust the natural gas fuel FN and the mixed fuel FM of the natural gas fuel FN and the hydrogen fuel FH. An upper limit value of a hydrogen co-combustion rate in each of the main combustion burners 60 is less than 100%.

In the following description, an operation with a hydrogen co-combustion rate (calorie ratio), which is a ratio of the hydrogen fuel FH in the fuel F injected from the pilot combustion burner 50, being equal to or less than a specified value th is referred to as an operation at a low hydrogen co-combustion rate, and an operation with the hydrogen co-combustion rate in the pilot combustion burner 50 exceeding the specified value th is referred to as an operation at a high hydrogen co-combustion rate.

In the following description, the above specified value th is set to 0%, but the above specified value th may exceed 0%.

In the gas turbine 1 according to some embodiments, the pilot combustion burner 50 can be supplied with first fuel F1 and second fuel F2 having a higher content of the hydrogen fuel FH (hereinafter, also referred to as a hydrogen content) than the first fuel F1.

In the following description, the first fuel F1 is the natural gas fuel FN, and the second fuel F2 is the mixed fuel FM of the natural gas fuel FN and the hydrogen fuel FH or the hydrogen fuel FH. However, the first fuel F1 may contain the hydrogen fuel FH as long as the hydrogen content of the first fuel F1 is lower than that of the second fuel F2.

### About Supply of Water W

In the gas turbine 1 according to some embodiments, when a hydrogen co-combustion rate is increased, a temperature of a flame tends to rise, and an amount of NOx generated tends to increase. In addition, there is a concern that a metal temperature of the combustor 4 may rise due to the rise in the temperature of the flame, thereby causing damage.

For example, in the gas turbine 1 according to some embodiments, when the hydrogen co-combustion rate in the pilot combustion burner 50 is increased, a metal temperature of the cone portion 56b may rise, which may cause damage to the cone portion 56b.

Therefore, in an operation method for the gas turbine 1 according to some embodiments, a flame temperature is suppressed, a generation of NOx is suppressed, and a possibility of damage to the combustor 4 is suppressed by supplying the water W to the pilot nozzle 54 and injecting the water W from the pilot nozzle 54 as follows.

In the operation method for the gas turbine 1 according to some embodiments, in a case of performing the operation at the low hydrogen co-combustion rate, the first fuel F1 is injected from the first injection hole 101.

That is, the combustion controller 140 regulates the opening degrees of the natural gas regulation valve 241 and the hydrogen regulation valve 242 to inject the first fuel F1 from the first injection hole 101. In this manner, the first fuel F1 is injected from the first injection hole 101 via the fuel supply line 211 and via the first flow path 111 of the pilot nozzle 54.

In the operation method for the gas turbine 1 according to some embodiments, in a case where the operation at the high hydrogen co-combustion rate is performed, the second fuel F2 is injected from the first injection hole 101, and the water W is injected from the second injection hole 102.

That is, the combustion controller 140 regulates the opening degrees of the natural gas regulation valve 241 and the hydrogen regulation valve 242 to inject the second fuel F2 from the first injection hole 101. In this manner, the second fuel F2 is injected from the first injection hole 101 via the fuel supply line 211 and via the first flow path 111 of the pilot nozzle 54.

In addition, the combustion controller 140 regulates an opening degree of the second water regulation valve 244 to inject the water W from the second injection hole 102. In this manner, the water W is injected from the second injection hole 102 via the second water supply line 222 and via the second flow path 112 of the pilot nozzle 54.

In this way, in the operation method for the gas turbine 1 according to some embodiments, the flame temperature can be suppressed by injecting the water W from the second injection hole 102 in a case where the operation at the high hydrogen co-combustion rate is performed. Therefore, the generation of NOx can be suppressed while increasing a co-combustion rate of hydrogen and the possibility of damage to the combustor 4 can be suppressed.

In the operation method for the gas turbine 1 according to some embodiments, in a case where the operation at the high hydrogen co-combustion rate is performed, a mixture FW2 of the second fuel F2 and the water W may be injected from the first injection hole 101, and the water W may be injected from the second injection hole 102.

That is, the combustion controller 140 regulates opening degrees of the natural gas regulation valve 241, the hydrogen regulation valve 242, and the first water regulation valve 243 to inject the mixture FW2 of the second fuel F2 and the water W from the first injection hole 101. In this manner, the second fuel F2 and the water W are mixed at the merging portion 218, and the mixture FW2 of the second fuel F2 and the water W is injected from the first injection hole 101 via the fuel supply line 211 and via the first flow path 111 of the pilot nozzle 54.

In addition, the combustion controller 140 regulates the opening degree of the second water regulation valve 244 to inject the water W from the second injection hole 102. In this manner, the water W is injected from the second injection hole 102 via the second water supply line 222 and via the second flow path 112 of the pilot nozzle 54.

In this manner, the flame temperature can be further suppressed.

In the operation method for the gas turbine 1 according to some embodiments, in a case where the operation at the high hydrogen co-combustion rate is performed, at least one of an injection amount of the water W injected from the first injection hole 101 or an injection amount of the water W injected from the second injection hole 102 may be increased as the hydrogen content of the second fuel F2 increases.

That is, when the mixture FW2 of the second fuel F2 and the water W is injected from the first injection hole 101, the combustion controller 140 regulates the opening degrees of the natural gas regulation valve 241, the hydrogen regulation valve 242, and the first water regulation valve 243 such that the opening degree of the first water regulation valve 243 increases as the opening degree of the hydrogen regulation valve 242 increases.

In addition, when the water W is injected from the second injection hole 102, instead of increasing the opening degree of the first water regulation valve 243 as the opening degree of the hydrogen regulation valve 242 increases as described above, or together with increasing the opening degree of the first water regulation valve 243 as the opening degree of the hydrogen regulation valve 242 increases, the combustion controller 140 regulates the opening degree of the second water regulation valve 244 such that the opening degree of the second water regulation valve 244 increases as the opening degree of the hydrogen regulation valve 242 increases.

In this manner, in a case where the operation at the high hydrogen co-combustion rate is performed, as the hydrogen content of the second fuel F2 increases, at least one of the injection amount of the water W injected from the first injection hole 101 or the injection amount of the water W injected from the second injection hole 102 increases.

Therefore, the temperature of the flame, which rises as the hydrogen content of the second fuel F2 increases, can be suppressed by increasing the injection amount of the water W.

In the operation method for the gas turbine 1 according to some embodiments, in a case of transitioning from the operation at the low hydrogen co-combustion rate to the operation at the high hydrogen co-combustion rate, the first fuel F1 may be injected from the first injection hole 101, then a mixture FW1 of the first fuel F1 and the water W may be injected from the first injection hole 101, and then the mixture FW2 of the second fuel F2 and the water W may be injected from the first injection hole 101.

That is, in a case of transitioning from the operation at the low hydrogen co-combustion rate to the operation at the high hydrogen co-combustion rate, the combustion controller 140 regulates the opening degrees of the natural gas regulation valve 241 and the hydrogen regulation valve 242 to inject the first fuel F1 from the first injection hole 101. In this manner, the first fuel F1 is injected from the first injection hole 101 via the fuel supply line 211 and via the first flow path 111 of the pilot nozzle 54.

Next, the combustion controller 140 regulates the opening degrees of the natural gas regulation valve 241, the hydrogen regulation valve 242, and the first water regulation valve 243 to inject the mixture FW1 of the first fuel F1 and the water W from the first injection hole 101. In this manner, the first fuel F1 and the water W are mixed at the merging portion 218, and the mixture FW1 of the first fuel F1 and the water W is injected from the first injection hole 101 via the fuel supply line 211 and via the first flow path 111 of the pilot nozzle 54.

Next, the combustion controller 140 regulates the opening degrees of the natural gas regulation valve 241, the hydrogen regulation valve 242, and the first water regulation valve 243 to inject the mixture FW2 of the second fuel F2 and the water W from the first injection hole 101. In this manner, the second fuel F2 and the water W are mixed at the merging portion 218, and the mixture FW2 of the second fuel F2 and the water W is injected from the first injection hole 101 via the fuel supply line 211 and via the first flow path 111 of the pilot nozzle 54.

In this manner, the flame temperature can be suppressed by starting the injection of the water W before transitioning to the operation at the high hydrogen co-combustion rate.

In the operation method for the gas turbine 1 according to some embodiments, in a case of transitioning from the operation at the low hydrogen co-combustion rate to the operation at the high hydrogen co-combustion rate, the mixture FW1 of the first fuel F1 and the water W may be injected from the first injection hole 101, and then the water W may be injected from the second injection hole 102.

That is, in a case of transitioning from the operation at the low hydrogen co-combustion rate to the operation at the high hydrogen co-combustion rate, the combustion controller 140 regulates the opening degrees of the natural gas regulation valve 241, the hydrogen regulation valve 242, and the first water regulation valve 243 to inject the mixture FW1 of the first fuel F1 and the water W from the first injection hole 101. In this manner, the first fuel F1 and the water W are mixed at the merging portion 218, and the mixture FW1 of the first fuel F1 and the water W is injected from the first injection hole 101 via the fuel supply line 211 and via the first flow path 111 of the pilot nozzle 54.

Next, the combustion controller 140 regulates the opening degree of the second water regulation valve 244 to inject the water W from the second injection hole 102. In this manner, the water W is injected from the second injection hole 102 via the second water supply line 222 and via the second flow path 112 of the pilot nozzle 54.

In this manner, excessive injection of the water W can be suppressed by sequentially performing the injection of the mixture FW1 of the first fuel F1 and the water W from the first injection hole 101 and the injection of the water W from the second injection hole 102.

In the operation method for the gas turbine 1 according to some embodiments, in a case where the operation at the high hydrogen co-combustion rate is performed, the water W may be injected from the second injection hole 102, and the water W may be injected from the third injection hole 103.

That is, in a case where the operation at the high hydrogen co-combustion rate is performed, the combustion controller 140 regulates the opening degree of the second water regulation valve 244 to inject the water W from the second injection hole 102. In this manner, the water W is injected from the second injection hole 102 via the second water supply line 222 and via the second flow path 112 of the pilot nozzle 54.

In addition, in a case where the operation at the high hydrogen co-combustion rate is performed, the combustion controller 140 regulates an opening degree of the third water regulation valve 245 to inject the water W from the third injection hole 103. In this manner, the water W is injected from the third injection hole 103 via the third water supply line 223 and via the third flow path 113 of the pilot nozzle 54.

In this manner, the flame temperature can be further suppressed by increasing the injection amount of the water W.

In the pilot nozzle 54 according to some embodiments, the first injection hole 101 is disposed outside the second injection hole 102 in the radial direction about the central axis Axp of the pilot nozzle 54.

In this manner, the flame temperature can be further suppressed while ensuring flame retaining property.

In the gas turbine 1 according to some embodiments, the second fuel F2 can be obtained by mixing the first fuel F1 with the hydrogen fuel FH.

That is, in the gas turbine 1 according to some embodiments, as illustrated in FIG. 5, the second fuel F2 can be obtained by mixing the natural gas fuel FN serving as the first fuel F1 with the hydrogen fuel FH w at the merging portion 217.

In this manner, the second fuel can be easily obtained.

In the gas turbine 1 according to some embodiments, the fuel supply line 211, which is a fuel flow path for supplying the second fuel F2 to the first injection hole 101, is connected to the pilot nozzle 54. In a case where the mixture FW2 of the second fuel F2 and the water W is injected from the first injection hole 101, the second fuel F2 flowing through the fuel supply line 211, which is a fuel flow path, may be mixed with the water W.

That is, the gas turbine 1 according to some embodiments is configured such that, as illustrated in FIG. 5, the water W can be supplied to the fuel supply line 211 at the merging portion 218 on the downstream side of the merging portion 217 where the natural gas fuel FN from the supply source 201 for the natural gas fuel FN and the hydrogen fuel FH from the supply source 202 for the hydrogen fuel FH are mixed.

In this manner, the second fuel F2 is mixed with the water W immediately before the mixture FW2 of the second fuel F2 and the water W is injected, so that the water W can be injected while the water W remains dispersed in the second fuel F2.

In the gas turbine 1 according to some embodiments, the combustor 4 includes the pilot nozzle 54 and the main nozzle 64.

According to the gas turbine 1 according to some embodiments, the flame temperature can be suppressed while the fuel F containing hydrogen is combusted in the pilot nozzle 54.

The present disclosure is not limited to the above-described embodiments, and also includes a form in which modifications are added to the above-described embodiments or a form in which the embodiments are combined with each other as appropriate.

For example, in the operation method for the gas turbine 1 according to some embodiments, in a case where the water W is injected from the second injection hole 102, the water W may be injected from the third injection hole 103 instead of the water W being injected from the second injection hole 102, and in a case where the water W is injected from the third injection hole 103, the water W may be injected from the second injection hole 102 instead of the water W being injected from the third injection hole 103.

In the operation method for the gas turbine 1 according to some of the above-described embodiments, in a case where the operation at the high hydrogen co-combustion rate is performed, only the second fuel F2 may be injected from some first injection holes 101 of the plurality of the first injection holes 101, and the mixture FW2 of the second fuel F2 and the water W may be injected from remaining first injection holes 101.

For example, contents described in each of the above-described embodiments are understood as follows.

(1) An operation method for a gas turbine 1 according to at least one embodiment of the present disclosure is an operation method for a gas turbine 1 including a combustor 4 capable of using hydrogen and fuel other than hydrogen as fuel. The combustor 4 includes a nozzle (pilot nozzle 54) having at least one first injection hole 101 and at least one second injection hole 102. The operation method for a gas turbine 1 according to at least one embodiment of the present disclosure includes injecting first fuel F1 from the at least one first injection hole 101 in a case of performing an operation at a low hydrogen co-combustion rate, and injecting second fuel F2 having a higher hydrogen content than the first fuel F1 from the at least one first injection hole 101 and injecting water W from the at least one second injection hole 102 in a case of performing an operation at a high hydrogen co-combustion rate, in which a hydrogen co-combustion rate is higher than the operation at the low hydrogen co-combustion rate.

According to the method of (1) above, the flame temperature can be suppressed by injecting the water W from the second injection hole 102 in a case where the operation at the high hydrogen co-combustion rate is performed. Therefore, the generation of NOx can be suppressed while increasing the co-combustion rate of hydrogen and the possibility of damage to the combustor 4 can be suppressed.

(2) In some embodiments, in the method of (1) above, in a case where the operation at the high hydrogen co-combustion rate is performed, a mixture FW2 of the second fuel F2 and the water W may be injected from the at least one first injection hole 101 and the water W may be injected from the at least one second injection hole 102.

According to the method of (2) above, the flame temperature can be further suppressed.

(3) In some embodiments, in the method of (1) or (2) above, the at least one first injection hole 101 may be disposed outside the at least one second injection hole 102 in a radial direction about a central axis Axp of the nozzle (pilot nozzle 54).

According to the method of (3) above, the flame temperature can be further suppressed while ensuring flame retaining property.

(4) In some embodiments, in the method of any one of (1) to (3) above, in a case where the operation at the high hydrogen co-combustion rate is performed, at least one of an injection amount of the water W injected from the at least one first injection hole 101 or an injection amount of the water W injected from the at least one second injection hole 102 may be increased as the hydrogen content of the second fuel F2 increases.

According to the method of (4) above, the temperature of the flame, which rises as the hydrogen content of the second fuel F2 increases, can be suppressed by increasing the injection amount of the water W.

(5) In some embodiments, in the method of (2) above, in a case of transitioning from the operation at the low hydrogen co-combustion rate to the operation at the high hydrogen co-combustion rate, the first fuel F1 may be injected from the at least one first injection hole 101, then a mixture FW1 of the first fuel F1 and the water W may be injected from the at least one first injection hole 101, and then the mixture FW2 of the second fuel F2 and the water W may be injected from the at least one first injection hole 101.

According to the method of (5) above, the flame temperature can be suppressed by starting the injection of the water W before transitioning to the operation at the high hydrogen co-combustion rate.

(6) In some embodiments, in the method of (5) above, in a case of transitioning from the operation at the low hydrogen co-combustion rate to the operation at the high hydrogen co-combustion rate, the mixture FW1 of the first fuel Fl and the water W may be injected from the at least one first injection hole 101, and then the water W may be injected from the at least one second injection hole 102.

According to the method of (6) above, the excessive injection of the water W can be suppressed by sequentially performing the injection of the mixture FW1 of the first fuel F1 and the water W from the at least one first injection hole 101 and the injection of the water W from the at least one second injection hole 102.

(7) In some embodiments, in the method of any one of (1) to (6) above, the nozzle (pilot nozzle 54) may have at least one third injection hole 103. In a case where the operation at the high hydrogen co-combustion rate is performed, the water W may be injected from the at least one second injection hole 102 and the water W may be injected from the at least one third injection hole 103.

According to the method of (7) above, the flame temperature can be further suppressed by increasing the injection amount of the water W.

(8) In some embodiments, in the method of any one of (1) to (7) above, the second fuel F2 may be obtained by mixing the first fuel F1 with the hydrogen (hydrogen fuel FH).

According to the method of (8) above, the second fuel F2 can be easily obtained.

(9) In some embodiments, in the method of (8) above, a fuel flow path (fuel supply line 211) for supplying the second fuel F2 to the at least one first injection hole 101 may be connected to the nozzle (pilot nozzle 54). In a case where a mixture FW2 of the second fuel F2 and the water W is injected from the at least one first injection hole 101, the second fuel F2 flowing through the fuel flow path (fuel supply line 211) may be mixed with the water W.

According to the method of (9) above, the second fuel F2 is mixed with the water W immediately before the mixture FW2 of the second fuel F2 and the water W is injected, so that the water W can be injected while the water W remains dispersed in the second fuel F2.

(10) In some embodiments, in the method of any one of (1) to (9) above, the combustor 4 may include the nozzle (pilot nozzle 54) as a pilot nozzle 54 and include a main nozzle 64.

According to the method of (10) above, the flame temperature can be suppressed while the fuel F containing hydrogen is combusted in the pilot nozzle 54.

### REFERENCE SIGNS LIST

1: gas turbine
4: gas turbine combustor (combustor)
50: pilot combustion burner
54: pilot nozzle
60: main combustion burner
64: main nozzle
101: first injection hole
102: second injection hole
103: third injection hole
111: first flow path
112: second flow path
113: third flow path
140: combustion controller
200: supply system
211: fuel supply line

1. An operation method for a gas turbine including a combustor capable of using hydrogen and fuel other than hydrogen as fuel, in which the combustor includes a nozzle having at least one first injection hole and at least one second injection hole, the method comprising:
injecting first fuel from the at least one first injection hole in a case of performing an operation at a low hydrogen co-combustion rate; and
injecting second fuel having a higher hydrogen content than the first fuel from the at least one first injection hole and injecting water from the at least one second injection hole in a case of performing an operation at a high hydrogen co-combustion rate, in which a hydrogen co-combustion rate is higher than the operation at the low hydrogen co-combustion rate.

2. The operation method for a gas turbine according to claim 1,
wherein, in a case where the operation at the high hydrogen co-combustion rate is performed, a mixture of the second fuel and the water is injected from the at least one first injection hole and the water is injected from the at least one second injection hole.

3. The operation method for a gas turbine according to claim 1,
wherein the at least one first injection hole is disposed outside the at least one second injection hole in a radial direction about a central axis of the nozzle.

4. The operation method for a gas turbine according to claim 1,
wherein, in a case where the operation at the high hydrogen co-combustion rate is performed, at least one of an injection amount of the water injected from the at least one first injection hole or an injection amount of the water injected from the at least one second injection hole is increased as the hydrogen content of the second fuel increases.

5. The operation method for a gas turbine according to claim 2,
wherein, in a case of transitioning from the operation at the low hydrogen co-combustion rate to the operation at the high hydrogen co-combustion rate,
the first fuel is injected from the at least one first injection hole,
then a mixture of the first fuel and the water is injected from the at least one first injection hole, and
then the mixture of the second fuel and the water is injected from the at least one first injection hole.

6. The operation method for a gas turbine according to claim 5,
wherein, in a case of transitioning from the operation at the low hydrogen co-combustion rate to the operation at the high hydrogen co-combustion rate,
the mixture of the first fuel and the water is injected from the at least one first injection hole, and
then the water is injected from the at least one second injection hole.

7. The operation method for a gas turbine according to claim 1,
wherein the nozzle has at least one third injection hole, and,
in a case where the operation at the high hydrogen co-combustion rate is performed, the water is injected from the at least one second injection hole and the water is injected from the at least one third injection hole.

8. The operation method for a gas turbine according to claim 1,
wherein the second fuel is obtained by mixing the first fuel with the hydrogen.

9. The operation method for a gas turbine according to claim 8,
wherein a fuel flow path for supplying the second fuel to the at least one first injection hole is connected to the nozzle, and,
in a case where a mixture of the second fuel and the water is injected from the at least one first injection hole, the second fuel flowing through the fuel flow path is mixed with the water.

10. The operation method for a gas turbine according to claim 1,
wherein the combustor includes the nozzle as a pilot nozzle and includes a main nozzle.
